(19) United States
(12) Patent Application Publication
(10) Pub. No.: US 2014/0047182 A1
(43) Pub. Date: Feb. 13, 2014

(54) METHOD AND DEVICE FOR PROCESSSING DATA USING WINDOW

(71) Applicant: SAMSUNG ELECTRONICS CO., LTD., Suwon-si (KR)

(72) Inventors: Min Soo KIM, Yongin-si (KR); Do Hyung KIM, Hwaseong-si (KR); Chang Yong SON, Gunpo-si (KR); Kang Eun LEE, Hwaseong-si (KR)

(21) Appl. No.: 13/917,800

(22) Filed: Jun. 14, 2013

(30) Foreign Application Priority Data
Aug. 8, 2012 (KR) 10-2012-0086657

(51) Int. Cl. G06F 12/08

(52) U.S. Cl. CPC G06F 12/0802
USPC 711/118

(57) ABSTRACT

Provided are a data processing method and device using a window. The data processing method may include caching data by applying a window to data stored in a memory on a per channel basis, and transmitting the cached data to a core processor using location information of a point.

### CROSS-REFERENCE TO RELATED APPLICATION(S)

This application claims the benefit under 35 USC §119(a) of Korean Patent Application No. 10-2012-0086657, filed on Aug. 8, 2012, in the Korean Intellectual Property Office, the entire disclosure of which is incorporated herein by reference for all purposes.

### BACKGROUND

1. Field

The following description relates to a method and device for caching data stored in a memory using a window and providing the cached data.

2. Description of Related Art

Beamforming is a signal-processing technique used in various applications such as wireless communications, radar, and sonar that use an array of sensors or elements for transmitting and receiving radio or sound waves. Beamforming enables directional or spatial selectivity of signal transmission or reception. Recently, in medical ultrasound imaging apparatuses, beamforming is used to focus signals received as reflections from different tissue structures in a region of interest.

Beamforming may be performed using data stored in multiple channels such as in the ultrasonic imaging apparatus. However, independent access to the respective channels is required. When performing a single channel access, which denotes the independent access per channel, a waiting time occurs during each access. In this case, a bandwidth of a memory storing the data may be wasted.

Accordingly, there is a need for a method of reducing an amount of calculations for beamforming and preventing a waste of the bandwidth of the memory.

### SUMMARY

In an aspect, there is provided a data processing method including applying a window to data stored in a memory according to channels, and accessing and caching the data included in the applied window.

The applying of the window may comprise determining a width of the window based on a channel related to the data.

The applying of the window may comprise determining a depth of the window based on a probe used to collect the data.

The data processing method may further comprise receiving location information of a point from a core processor, the point being used for performing beamforming, extracting data used for beamforming according to channels from the cached data based on the location information and a delay profile, and merging the data extracted according to channels and providing the merged data to the core processor.

The delay profile may be determined based on a predetermined sound speed or a lookup table related to the delay.

The extracting of the data may comprise using cached data from one window according to the location information provided by a plurality of core processors.

The extracting of the data may comprise using cached data from multiple windows having different scan lines and/or different depths according to the location information provided by a plurality of core processors.

The location information of the point may comprise at least one of a location of a scan line related to the point and a location of the point on the scan line.

In an aspect, there is provided a data processing method including caching data stored in a memory using a window of the data, receiving location information of a point from a core processor, the point being used for performing beamforming, extracting data for beamforming according to channels from the cached data based on the location information of the point, and merging the data extracted according to channels and providing the merged data to the core processor.

A width of the window may be determined according to a channel related to the data and/or a depth of the window may be determined according to a probe used in collecting the data.

In an aspect, there is provided a data processing device including a window application unit configured to apply a window to data stored in a memory according to channels, and a data cache unit configured to access and cache the data included in the window.

The window application unit may determine a width of the window based on a channel related to the data.

The window application unit may determine a depth of the window based on a probe used in collecting the data.

The data processing device may further comprise a receiving unit configured to receive location information of a point from a core processor, the point being used for performing beamforming, and a data extraction unit configured to extract data for beamforming according to channels from the cached data based on the location information and a delay profile, and a data providing unit configured to merge the data extracted according to channels and provide the merged data to the core processor.

The delay profile may be determined based on a predetermined sound speed or a lookup table related to a delay.

The data extraction unit may use cached data from one window according to the location information provided by a plurality of core processors.

The data extraction unit may use cached data from multiple windows having different scan lines and/or different depths according to the location information provided by a plurality of core processors.

The location information of the point may comprise at least one of a location of a scan line related to the point and a location of the point on the scan line.

In an aspect, there is provided a data processing device including a data cache unit configured to cache data stored in a memory using a window of the data, a location information receiving unit configured to receive location information of a point from a core processor, the point being used for performing beamforming, a data extraction unit configured to extract data for beamforming according to channels from the cached data based on the location information of the point, and a data providing unit configured to merge the data extracted according to channels and provide the merged data to the core processor.

A width of the window may be determined according to a channel related to the data and/or a depth of the window may be determined according to a probe used in collecting the data.

Other features and aspects will be apparent from the following detailed description, the drawings, and the claims.

### BRIEF DESCRIPTION OF THE DRAWINGS

FIG. 1 is a diagram illustrating an example of a system including a data processing device.

FIG. 2 is a diagram illustrating another example of a data processing device.

FIG. 3 is a diagram illustrating an example of a beam transmitting process for storing data.

FIG. 4 is a diagram illustrating an example of a beam receiving process for storing data.

FIG. 5 is a diagram illustrating an example of a process of storing data in a memory.

FIG. 6 is a diagram illustrating an example of location information of a point.

FIG. 7 is a diagram illustrating an example of a process of using data cached by a window.

FIG. 8 is a diagram illustrating an example of a process of transmitting data to one core processor.

FIG. 9 is a diagram illustrating an example of a process of transmitting data to a to plurality of core processors.

FIG. 10 is a diagram illustrating an example of a method of caching data.

FIG. 11 is a diagram illustrating an example of a method of providing data.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, description of well-known functions and constructions may be omitted for increased clarity and conciseness.

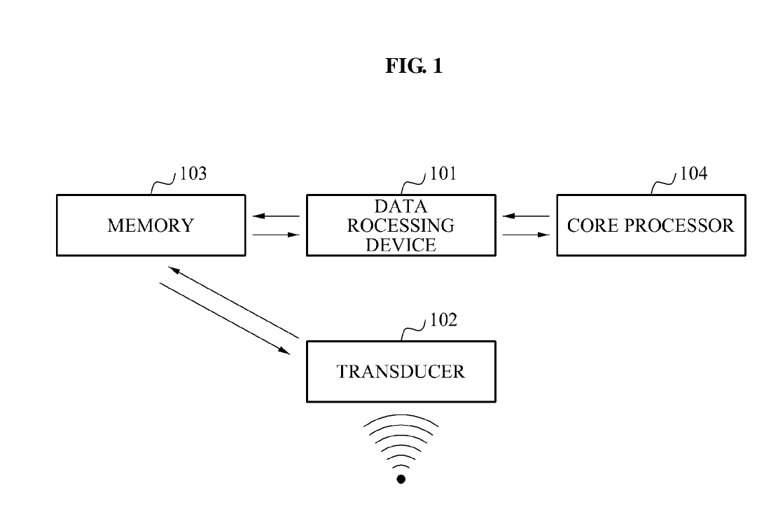

FIG. 1 illustrates an example of a system including a data processing device 101. The data processing device 101 may be included in a terminal, for example, an imaging apparatus, an appliance, and the like.

Referring to FIG. 1, the system includes the data processing device 101, a transducer 102, a memory 103, and a core processor 104. While depicted as separate components for ease of explanation, it should be appreciated that one or more of the components may be physically combined in implementation.

The transducer 102 may output a beam with respect to a focused point. The focused point corresponds to a target region that is to be checked by the beam. For example, the beam may be output linearly or according to a predetermined waveform such as a spherical wave or a plane wave. The transducer 102 may include a plurality of sensors installed on a front of a probe for ultrasonic image diagnosis. An ultrasonic image may be generated through the sensors.

According to various aspects, the transducer 102 may be a plurality of transducers 102. When beams output from the transducers 102 return, beams received by the transducers 102, which corresponds to a particular channel, may be recorded as radio frequency (RF) data in a memory 103. Here, the transducer 102 may be included in the probe. A beam received by the transducer 102 included in the probe may be an analog signal. The analog signal may be converted to the RF data, that is, a digital signal, and stored in the memory 103.

The memory 103 may store the RF data that is used for the ultrasonic image diagnosis according to the channels. Because the RF data is typically large in size, the RF data may be stored in the memory 103 disposed outside of the data processing device 101. For example, the memory 103 may be a dynamic random access memory (DRAM).

When single access is performed by the core processor 103 due to characteristics of the memory 103 of the DRAM type, waste of a bandwidth of the memory 103 may occur. According to various aspects herein, the data processing device 101 may apply a window to the data stored in the memory 103 to cache the data in advance thus preventing the waste of bandwidth of the memory 103.

When the core processor 104 performs single access, the core processor 104 separately calculates a delay for selecting a channel for the single access. The delay calculation may increase an overall calculation of the core processor 104. Therefore, the data processing device 101 may extract the data cached by the window according to a predetermined delay profile. Consequently, a delay operation that is performed by the core processor 104 may be reduced thus increasing the speed of the core processor 104.

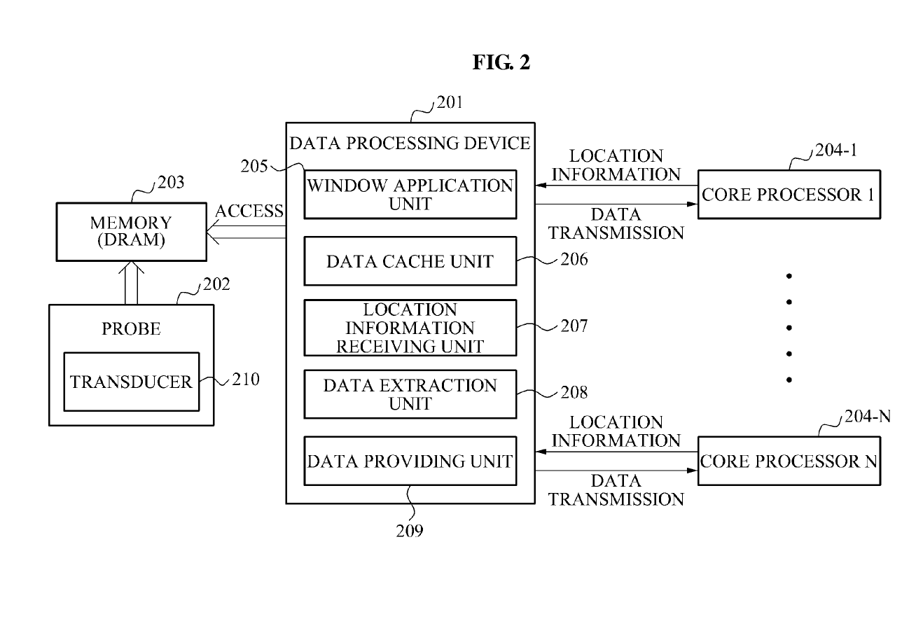

FIG. 2 illustrates an example of a data processing device 201.

Referring to FIG. 2, the data processing device 201 includes a window application unit 205 and a data cache unit 206. Additionally, the data processing device 201 may include a location information receiving unit 207, a data extraction unit 208, and/or a data providing unit 209.

The window application unit 205 may apply a window to a memory 203 recording RF data based on a beam emitted through a transducer 210. As described herein, the window denotes a unit of access for access to the data stored in the memory 203. The window application unit 205 may apply the window to part of the RF data stored in the memory 203.

A width of the window may be determined based on a channel related to the RF data. For example, as a number of channels used in recording the RF data increases, the width of the window may be increased. A depth, that is, a height of the window may be determined based on a probe 202 used in collecting the RF data. For example, the depth of the window may be smaller when the probe 202 is a linear probe in comparison to when the probe 202 is a phased probe. Accordingly, a shape of the window may be determined by a type of the probe used for collecting the RF data and the number of channels used for storing the RF data.

The data cache unit 206 may access and cache the RF data included in the window. For example, the data cache unit 206 may temporarily store the RF data in an internal memory of the data processing device 201 so that a core processor 1 204-1 through a core processor N 204-N may use the RF data. The data cache unit 206 may apply the window to the memory 203 and load RF data corresponding to the window. Next, the data cache unit 206 may transmit the loaded RF data to the data processing device 201, for example, according to a burst transmission method.

The location information receiving unit 207 may receive location information of a point from the core processor 1 204-1 to the core processor N 204-N. Here, the location information of the point refers to location information of a point for performing beamforming For example, the location information of the point may be determined by a scan line on which the point is located or a location of the point on the scan line.

The data extraction unit 208 may extract data to be used for beamforming according to channels. The data extraction unit 208 may extract from data that is cached based on the location information of the point and a delay profile. The delay profile may be predetermined information and may be corrected by the core processors 204-1 to 204-N. For example, the delay profile may be determined based on a sound speed and a lookup table related to a delay.

When there is a plurality of core processors 204-1 to 204-N, the data extraction unit 208 may use one window according to the location information provided by the core processors 204-1 to 204-N. For example, the data extraction unit 208 may extract data according to the location information of a point from data cached by the one window. That is, the one window may transmit RF data corresponding to different depth information according to the core processors.

As another example, the data extraction unit 208 may use a plurality of windows according to the location information provided by the core processors. For example, the data extraction unit 208 may extract data according to the location information of a point from data cached by the plurality of windows. That is, the RF data may be transmitted based on the plurality of windows corresponding to different location information according to the core processors. Here, the location information may include the scan line on which the point is located or depth information of the point located on a particular scan line.

The data providing unit 209 may merge the data extracted from the respective channels and transmit the merged data to the core processors 204-1 to the 204-N.

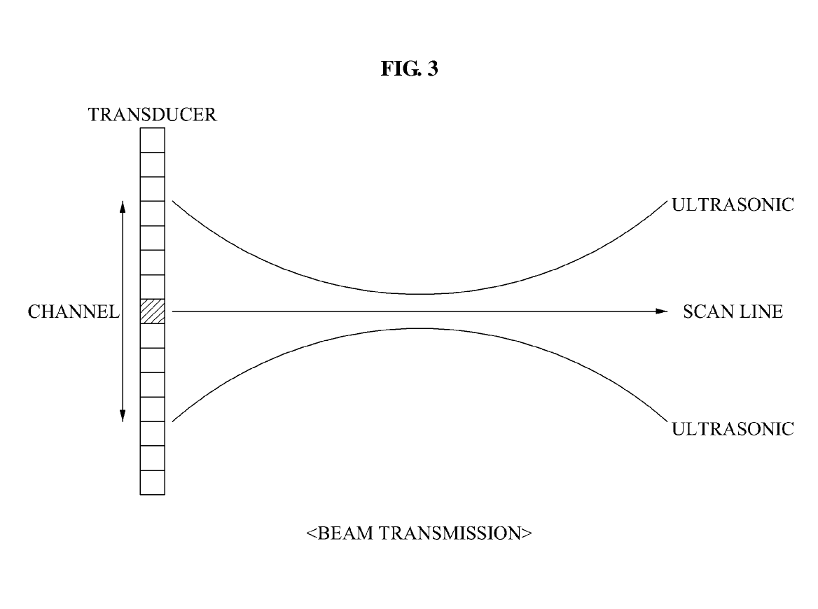

FIG. 3 illustrates an example of a beam transmitting process for storing data.

Referring to FIG. 3, a beam may be output from a particular point. For example, the beam may be emitted linearly or according to a predetermined waveform such as a spherical wave or a plane wave. The beam output from individual particular points may return to transducers to make up a particular channel. The beam received by the transducers constituting the particular channel may be recorded in a memory in the form of RF data. A scan line may be set per transducer. A particular point may refer to any one point on the scan line. A curved ultrasonic wave may be formed with respect to the particular point.

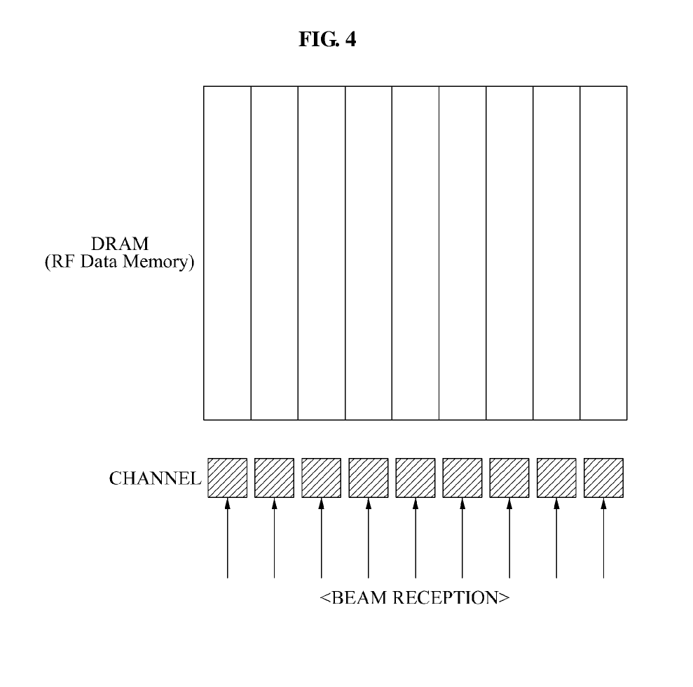

FIG. 4 illustrates an example of a beam receiving process for storing data.

Referring to FIG. 4, a beam emitted from a particular point may return to transducers to make up a channel. The beam may be recorded as RF data in a memory according to channels for a predetermined time.

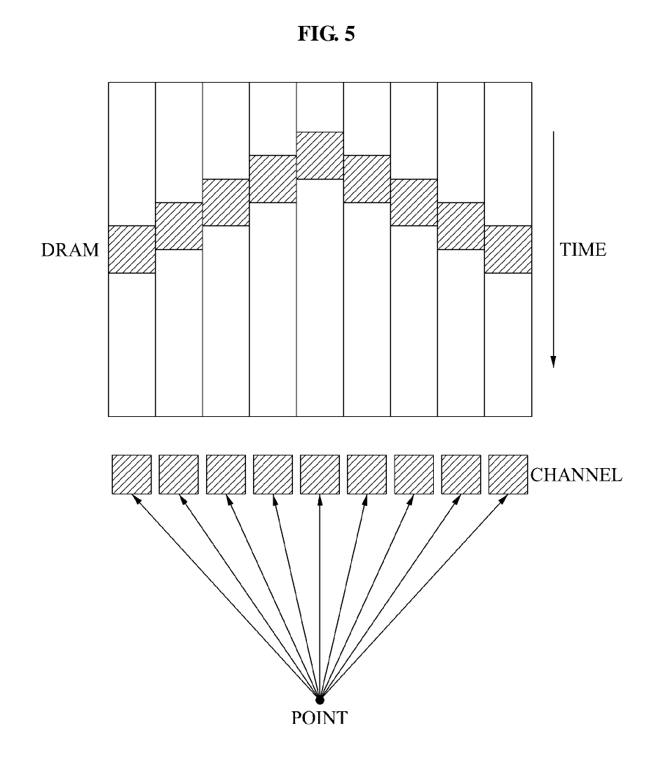

FIG. 5 illustrates an example of a process of storing data in a memory.

As described herein, the RF data may be stored in the memory according to the channels. For example, when the beam generated from the particular point is recorded in the memory, a distance between the particular point and the transducers may be varied according to the channels. The difference in the distance can cause a delay of a beam recording time. Accordingly, recording locations of the RF data in the memory may be varied depending on the channels. The delay may also be generated by a difference in a sound speed.

Referring to FIG. 5, the RF data may be recorded in the memory in an arc form rather than in a linear form. Accordingly, a time delay may be taken into consideration for access to the RF data recorded in the memory. According to various aspects, a data processing device may access the RF data by applying a window to the RF data corresponding to a channel belonging to a partial period, rather than according to the channels. When access to the RF data is performed by window processing, waste of a bandwidth of the memory necessary for the access may be reduced in comparison to when single access per channel is performed.

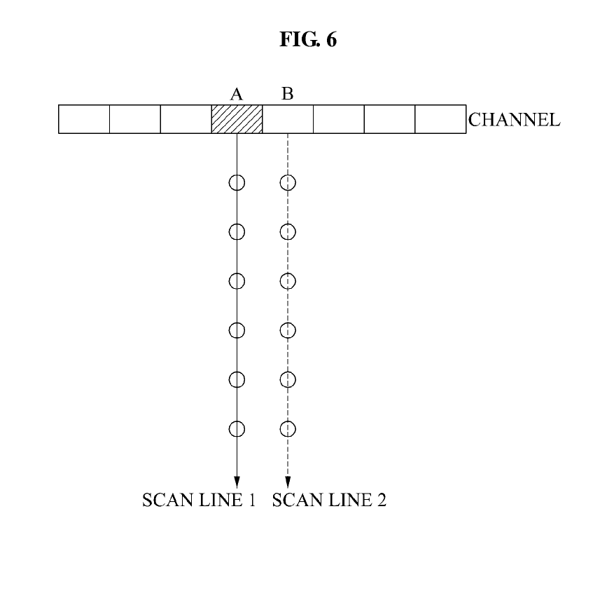

FIG. 6 illustrates an example of location information of a point.

According to various aspects, the data processing device may cache RF data corresponding to a predetermined period in advance using a window. The window may correspond to a plurality of channels, not a single channel. Therefore, the data processing device may transmit the RF corresponding to the location information out of the cached RF data, using the location information of the point received from a core processor. For example, the location information of the point may be defined by a scan line corresponding to each channel and depth information of the point on the scan line.

The core processor may transmit the location information of the point to the data processing device to obtain RF data, rather than directly accessing the RF data stored in the memory. Next, the core processor may receive from the data processing device the RF data corresponding to the location information of the point out of the RF data cached in advance using the window. Here, the data processing device may extract not only the location information of the point but also RF data requested by the core processor based on a predetermined delay profile. The predetermined delay profile may be reconfigured by the core processor according to a sound speed or a lookup table.

That is, the core processor may only provide the location information of the point of the RF data for beamforming to the data processing device. Accordingly, the core processor does not have to access the entire channel of the memory and calculate the delay.

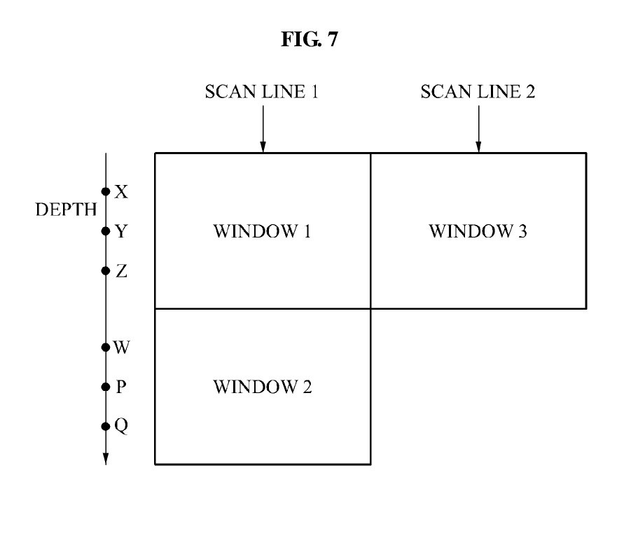

FIG. 7 illustrates an example of a process of using data cached by a window.

In this example, the data cached by the data processing device occurs when a plurality of core processors are used. For example, a core processor 1 may provide location information of a point corresponding to a depth X of a scan line 1 and a core processor 2 may provide location information of a point corresponding to a depth Z of a scan line 1.

In this example, the data processing device may provide RF data corresponding to the location information of the point provided by the core processor 1 and the core processor 2, extracted from the RF data cached by a window 1. That is, although the core processors are plural, the RF data cached by one window may be used.

As another example, the core processor 1 may provide location information of a point corresponding to the depth X of the scan line 1 and the core processor 2 may provide location information of a point corresponding to a depth Y of the scan line 2. In this example, the data processing device may extract RF data corresponding to the location information of the point provided by the core processor 1, from the RF data cached by the window 1. In addition, the data processing device may extract and provide RF data corresponding to the location information of the point provided by the core processor 2, from RF data cached by a window 3. In this example, RF data cached by the plurality of windows may be used according to the core processors.

As another example, the core processor 1 may provide the location information of a point corresponding to the depth X of the scan line 1 and the core processor 2 may provide location information of a point corresponding to a depth P of the scan line 1. In this example, the data processing device may extract RF data corresponding to the location information of the point provided by the core processor 1, from the RF data cached by the window 1. In addition, the data processing device may extract and provide RF data corresponding to the location information of the point provided by the core processor 2, from the RF data cached by a window 2.

Accordingly, when there are a plurality of core processors, the RF data cached by one window may be used. Also, when there are a plurality of core processors, the RF data cached by a plurality of windows may be used based on the scan line on which the point is located and/or the depth of the point on the scan line.

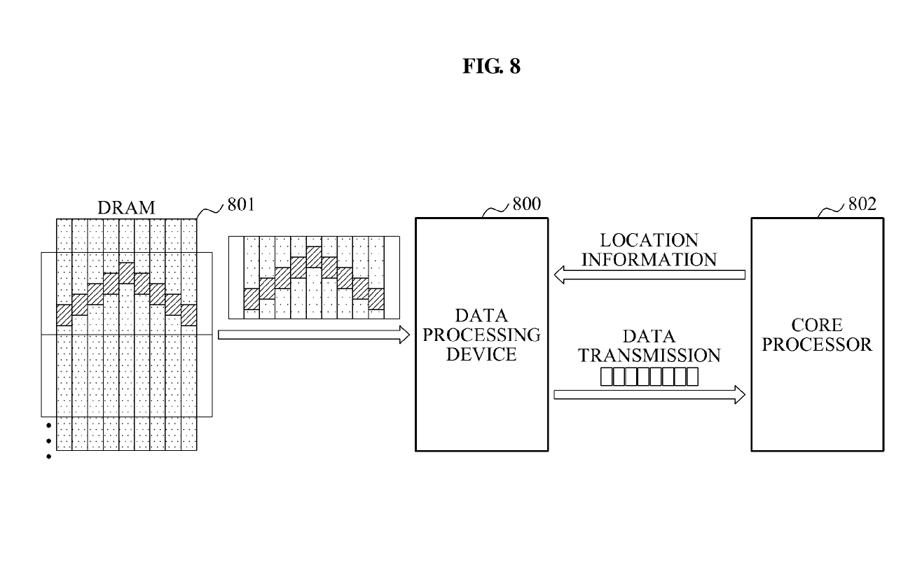

FIG. 8 illustrates an example of a process of transmitting data to one core processor.

Referring to FIG. 8, data processing device 800 may cache RF data stored in advance in a memory 801. For example, the memory 801 may be of a DRAM type. According to various aspects, the data processing device 800 may apply a window to the memory 801 and load RF data corresponding to the window, thereby receiving the RF data in a burst form.

Next, the data processing device 800 may receive location information of a point from a core processor 802. Therefore, the data processing device 800 may extract RF data per channel by considering the location information of the point and a delay corresponding to the location information based on a predetermined delay profile. The data processing device 800 may merge the RF data extracted from respective channels and provide the merged RF data to the core processor 802. In this example, the core processor 802 does not directly access the memory 801 but performs access through the data processing device 800.

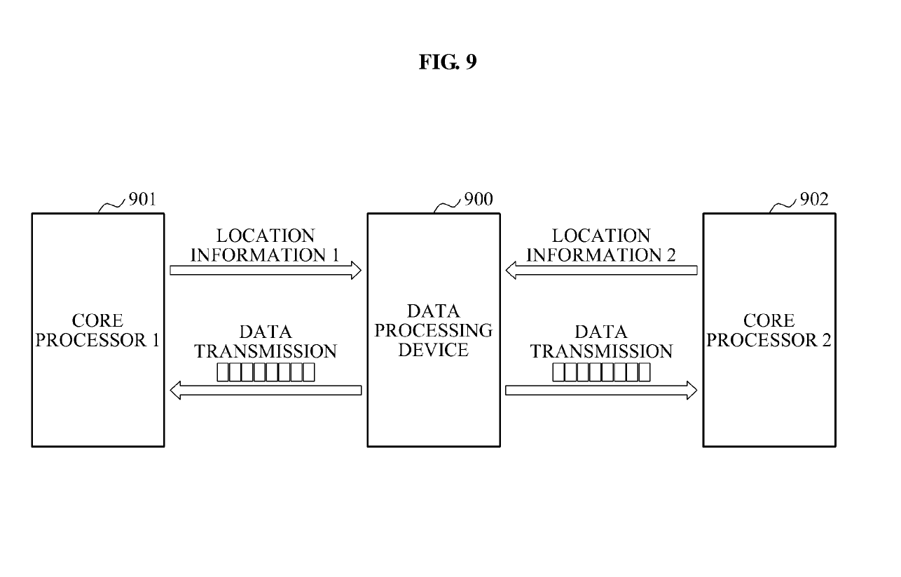

FIG. 9 illustrates an example of a process of transmitting data to a plurality of core processors.

Referring to FIG. 9, data processing device 900 may cache RF data stored in advance in a memory. That is, the data processing device 900 may apply a window to the memory and load RF data corresponding to the window, thereby receiving the RF data in a burst form.

In this example, the data processing device 900 may receive location information of a first point, that is, location information 1 from a core processor 1 901, and receive location information of a second point, that is, location information 2 from a core processor 2 902. Therefore, the data processing device 900 may extract RF data per channel by considering the location information of the point and a delay corresponding to each of the location information based on a predetermined delay profile. The data processing device 900 may merge the RF data extracted from respective channels and provide the merged RF data to the core processor 1 901 and the core processor 2 902.

The examples herein may be applied not only when the core processor is single but also when the core processors are plural. The data processing device may include a dedicated caching memory to process RF data requested by respective core processors. Therefore, the data processing device may process commands requested by the respective core processors separately.

In some examples, the data processing device may inform a corresponding core processor of a time that extraction of the RF data ends through an interrupt, so that the core processor may more efficiently operate. For convenience, two core processors are illustrated. However, more than two core processor may be included.

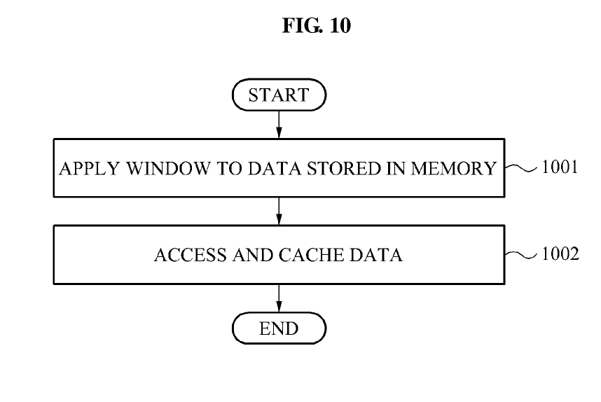

FIG. 10 illustrates an example of a process of caching data.

Referring to FIG. 10, in 1001, a window is applied to data stored in a memory. The data may be stored per channel of the memory. A width of the window may be determined based on a channel used in storing the data. For example, according to an increase in a number of the channels, the width of the window may likewise increase. In addition, a depth of the window may be determined based on a type of a probe used in storing the data. For example, the depth of the window may be smaller when the probe is a linear probe in comparison to when the probe is a phased probe.

In 1002, the data included in the window is accessed and cached. Thus, the data processing device may temporarily store the cached data.

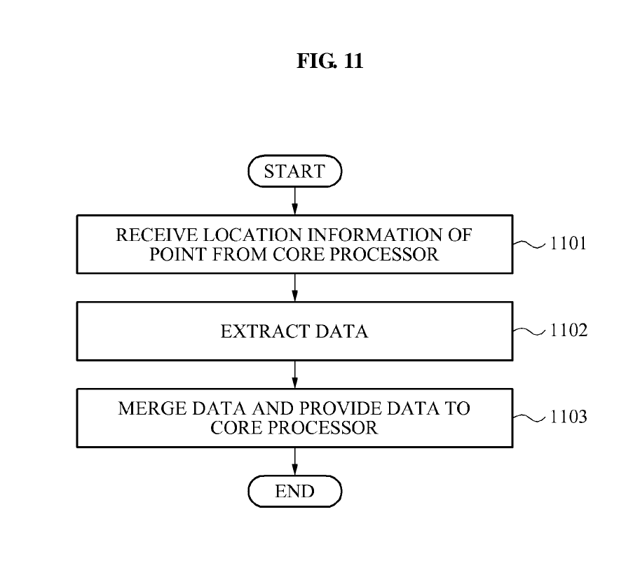

FIG. 11 illustrates an example of a process of providing data.

Referring to FIG. 11, in 1101, location information of a point for performing beamforming is received from a core processor.

In 1102, data for beamforming according to channels is extracted from data cached to by a window using the location information of the point and a predetermined delay profile. For example, the predetermined delay profile may be reconfigured based on a predetermined sound speed or a lookup table related to the delay. The data processing device may calculate the delay according to the channels based on the delay profile and thereby extract the data used for beamforming. The delay profile may be transmitted to the data processing device in advance by the core processor.

When a plurality of core processors are used, the data processing device may use data cached by one window or a plurality of different windows based on the location information provided by the core processors. For example, the plurality of different windows may be distinguished according to a location of a scan line included in the location information provided by the core processors and/or depth information of the point.

In 1103, the data extracted according to the channels is merged and provide to the core processors.

According to various aspects, the data processing device may cache RF data by applying a window to the RF data stored in a memory and receive the RF data through burst transmission. In addition, the data processing device may calculate a delay, select the RF data according to the channels to perform beamforming at a current location of the point requested by the core processor, and merge the RF data and transmit the RF data at once to the core processor.

According to various aspects, the data processing device as described in the above examples may prevent a waste of a bandwidth of the memory, which may be generated when the core processor performs single access directly to the RF data stored in an external memory for beamforming In addition, because the core processor does not directly calculate the delay, consumption of resources or a load of processing may be reduced.

Furthermore, when the core processor directly accesses the RF data stored in the external memory, the data processing device may prevent generation of a large amount of single random access induced due to discontinuity of the RF data.

In addition, the data processing device may reduce power consumption used by the core processor to calculate the delay to select the RF data stored in the memory.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data processing method comprising:
applying a window to data stored in a memory according to channels; and
accessing and caching the data included in the applied window.

2. The data processing method of claim 1, wherein the applying of the window comprises determining a width of the window based on a channel related to the data.

3. The data processing method of claim 1, wherein the applying of the window comprises determining a depth of the window based on a probe used to collect the data.

4. The data processing method of claim 1, further comprising:
receiving location information of a point from a core processor, the point being used for performing beamforming;
extracting data used for beamforming according to channels from the cached data based on the location information and a delay profile; and
merging the data extracted according to channels and providing the merged data to the core processor.

5. The data processing method of claim 4, wherein the delay profile is determined based on a predetermined sound speed or a lookup table related to the delay.

6. The data processing method of claim 4, wherein the extracting of the data comprises using cached data from one window according to the location information provided by a plurality of core processors.

7. The data processing method of claim 4, wherein the extracting of the data comprises using cached data from multiple windows having different scan lines and/or different depths according to the location information provided by a plurality of core processors.

8. The data processing method of claim 4, wherein the location information of the point comprises at least one of a location of a scan line related to the point and a location of the point on the scan line.

9. A data processing method comprising:
caching data stored in a memory using a window of the data;
receiving location information of a point from a core processor, the point being used for performing beamforming;
extracting data for beamforming according to channels from the cached data based on the location information of the point; and
merging the data extracted according to channels and providing the merged data to the core processor.

10. The data processing method of claim 9, wherein a width of the window is determined according to a channel related to the data and/or a depth of the window is determined according to a probe used in collecting the data.

11. A data processing device comprising:
a window application unit configured to apply a window to data stored in a memory according to channels; and
a data cache unit configured to access and cache the data included in the window.

12. The data processing device of claim 11, wherein the window application unit determines a width of the window based on a channel related to the data.

13. The data processing device of claim 11, wherein the window application unit determines a depth of the window based on a probe used in collecting the data.

14. The data processing device of claim 11, further comprising:
a receiving unit configured to receive location information of a point from a core processor, the point being used for performing beamforming;
a data extraction unit configured to extract data for beamforming according to channels from the cached data based on the location information and a delay profile; and
a data providing unit configured to merge the data extracted according to channels and provide the merged data to the core processor.

15. The data processing device of claim 14, wherein the delay profile is determined based on a predetermined sound speed or a lookup table related to a delay.

16. The data processing device of claim 14, wherein the data extraction unit uses cached data from one window according to the location information provided by a plurality of core processors.

17. The data processing device of claim 14, wherein the data extraction unit uses cached data from multiple windows having different scan lines and/or different depths according to the location information provided by a plurality of core processors.

18. The data processing device of claim 14, wherein the location information of the point comprises at least one of a location of a scan line related to the point and a location of the point on the scan line.

19. A data processing device comprising:
a data cache unit configured to cache data stored in a memory using a window of the data;
a location information receiving unit configured to receive location information of a point from a core processor, the point being used for performing beamforming;
a data extraction unit configured to extract data for beamforming according to channels from the cached data based on the location information of the point; and
a data providing unit configured to merge the data extracted according to channels and provide the merged data to the core processor.

20. The data processing device of claim 19, wherein a width of the window is determined according to a channel related to the data and/or a depth of the window is determined according to a probe used in collecting the data.
